(19) United States
(12) Patent Application Publication
(10) Pub. No.: US 2004/0085165 A1
(43) Pub. Date: May 6, 2004

(54) Band-trap filter

(76) Inventor: Yung-Rung Chung, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,650

(22) Filed: Nov. 5, 2002

(51) Int. Cl. H01P 1/202

(52) U.S. Cl. 333/206

(57) ABSTRACT

A band-trap filter includes a main body, an outer electrode, inner electrodes, strip-shaped wires, a signal input, a signal output, and a circuit board. The main body is made of a dielectric material with the outer electrode coating top, bottom, right, left, and rear sides thereof. The inner electrodes are provided inside the main body. The signal input and output are provided on the top side of the main body to electrically connect to the inner electrodes via the strip-shaped wires on the front side of the main body. Another strip-shaped wire electrically connects portions of the outer electrode at the top and the bottom side of the main body. Due to inductance and capacitance effects, the band-trap filter provides functions of both low-pass and high-pass filters and good electromagnetic interference rejection effect.

### FIELD OF THE INVENTION

The present invention relates to a band-trap filter, and more particularly to a filter that provides functions of both low-pass and high-pass filters due to inductance and capacitance effects, and thereby achieves a band-trap effect.

### BACKGROUND OF THE INVENTION

In general electric circuits, a major cause for noise interference is electromagnetic waves. The problem of electromagnetic interference (EMI) is particularly serious in high-frequency circuits. In view of the increasingly wide applications of digital circuits and analog circuits, it is necessary for circuit designers to choose interference-proof components to solve the problem of mutual interference between circuit modules. For a product with high-frequency circuit, even if it is a digital device with protective circuit, it would more or less be affected by the electromagnetic interference. Such external interference has even more serious influence on the application of broadband analog signal system as well as on the quality of wireless communication and the application of testing and controlling equipment.

It is therefore tried by the inventor to develop a band-trap filter to overcome the above-mentioned problems encountered by conventional electronic products.

### SUMMARY OF THE INVENTION

A primary object of the present invention is to provide a band-trap filter adapted for use in various microwave communication circuits to minimize the problem of electromagnetic interference and to provide functions of both low-pass and high-pass filters to achieve a band-trap effect.

To achieve the above and other objects, the band-trap filter of the present invention includes a main body, an outer electrode, inner electrodes, strip-shaped wires, a signal input, a signal output, and a circuit board. The main body is made of a dielectric material with top, bottom, right, left, and rear sides thereof coated by the outer electrode. The inner electrodes are provided inside the main body. The signal input and output are provided on the top side of the main body to electrically connect to the inner electrodes via the strip-shaped wires on the front side of the main body. Another strip-shaped wire electrically connects portions of the outer electrode at the top and the bottom side of the main body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a band-trap filter according to the present invention;

FIG. 2 is a top view of FIG. 1;

FIG. 3 is a front view of FIG. 1;

FIG. 4 shows the connection of conductors to the band-trap filter of the present invention; and

FIGS. 5 and 6 are graphs showing the waveforms obtained from tests conducted on the band-trap filter of the present invention.

### DETAILED DESCRIPTION OF THE PREFERRED EMBODIMENTS

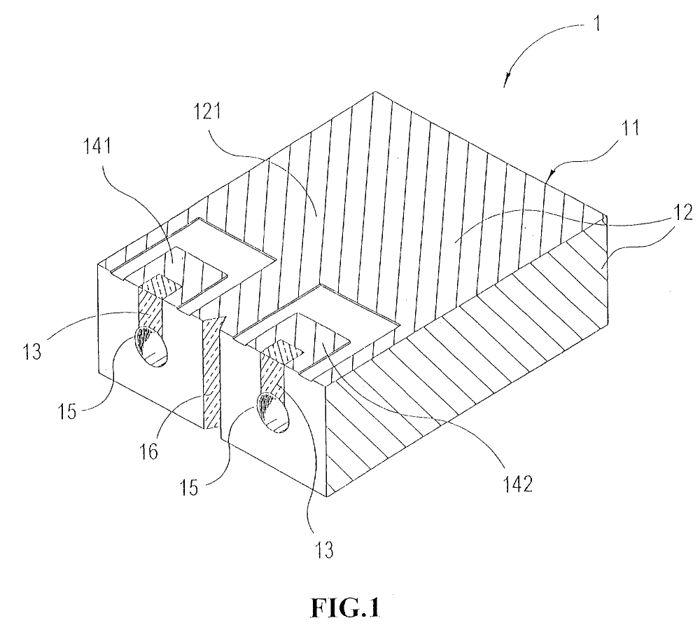

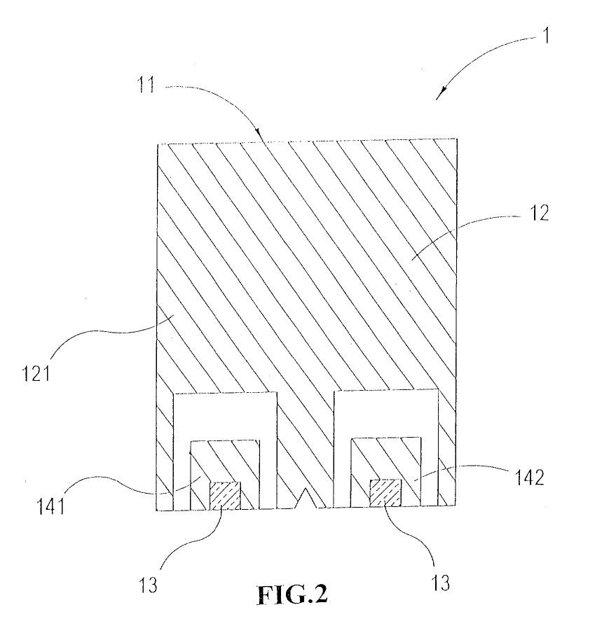

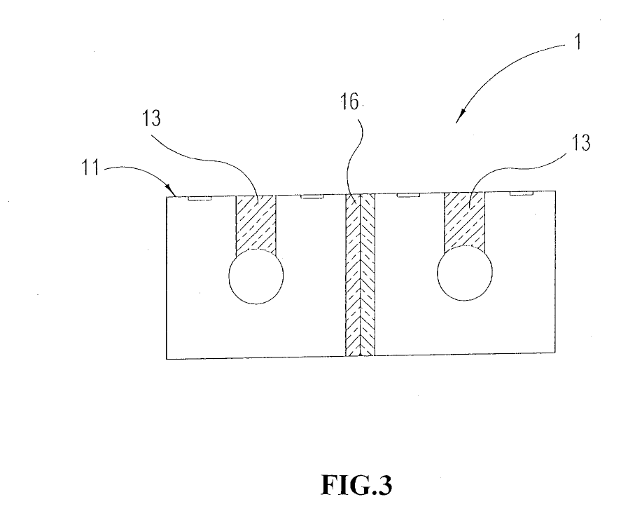

Please refer to FIGS. 1 to 3 that are perspective, top, and front views, respectively, of a band-trap filter 1 according to the present invention. As shown, the band-trap filter 1 mainly includes a main body 11, an outer electrode 12, inner electrodes 15, first strip-shaped wires 13, a signal input 141, and a signal output 142.

The main body 11 is made of a dielectric material and may be fabricated with lathe, miller or compressing die, or through sinter process. The dielectric material used to make the main body 11 may be one having a dielectric constant within the range from 2 to 200 or higher. The main body 11 is provided at all areas on four sides, including bottom, left, right, and rear sides, with the outer electrode 12. A top side of the main body 11 is also provided with the outer electrode 12 but is partially metalized to provide an electrode 121 and the signal input 141 and the signal output 142.

The outer electrode 12 coats the top, the bottom, the left, the right, and the rear side of the main body 11. Portions of the outer electrode 12 at the top and the bottom sides are electrically connected to each other by means of a second strip-shaped wire 16.

There are two inner electrodes 15 provided inside and electrically connected to the main body 11.

The signal input 141 and the signal output 142 are provided at the top side of the main body 11 for connecting to a printed circuit board (not shown) in order to input or output a signal. The signal input and output 141, 142 may be made into a shape of letter U. To form the signal input and output 141, 142, selected portions of the top side of the main body 11 are metalized and the outer electrode 12 within desired areas of the metalized portions are removed by means of, for example, sand blasting or cutting with suitable means, or using processes such as transfer printing, screen printing, and the like.

There are two striped wires 13 provided on the main body 11 to separately connect the signal input 141 and the signal output 142 to the two inner electrodes, 15.

The inner electrodes 15, the signal input 141, and the signal output 142 may be formed through vaporizing, chemically plating, electro plating or low-temperature sintering any one of copper, silver, gold, nickel, and tin material, and then fabricated with machines or other suitable means.

The first strip-shaped wires 13 may be formed through vaporizing, chemically plating, electro plating or low-temperature sintering any one of copper, silver, gold, nickel, and tin material, or in the form of metal films or metal wires for connecting to the inner electrodes 15 and the signal input and output 141, 142. When the forming of the main body 11, the production of the electrodes 12, 15, and the calibration and test of finished product are sequentially completed, a band-trap filter having elements capable of rejecting electromagnetic interference (EMI) and providing functions of both low-pass and high-pass filters is obtained to achieve a band-trap effect.

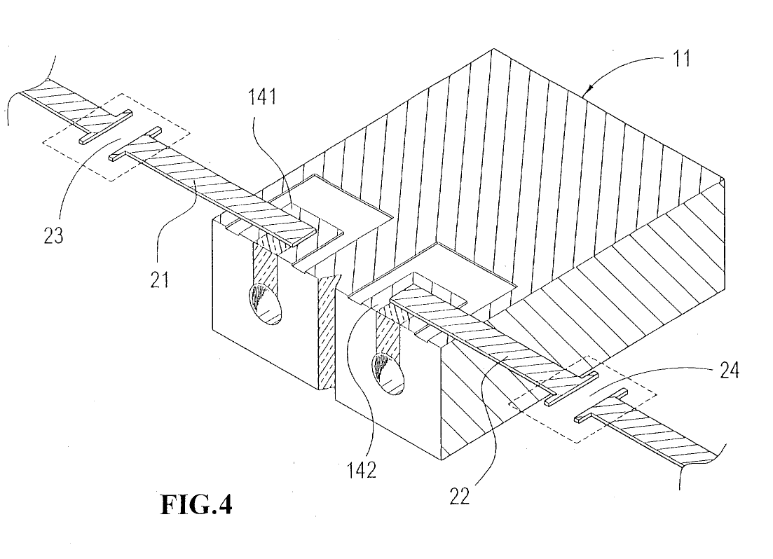

FIG. 4 shows the connection of conductors to the band-trap filter of the present invention. As can be seen from the drawing, two conductors 21, 22 of 50Ωare connected at an end to the signal input 141 and the signal output 142, respectively, on the main body 11 as lead-out wires, and capacitances 23, 24 are provided at the other end of the two conductors 21, 22, respectively.

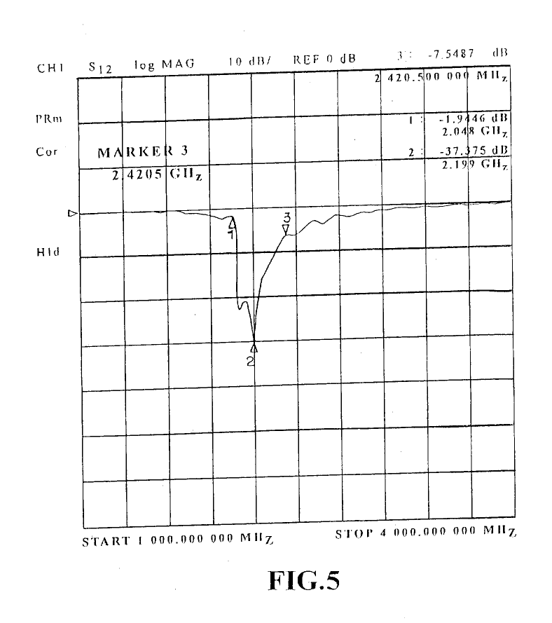

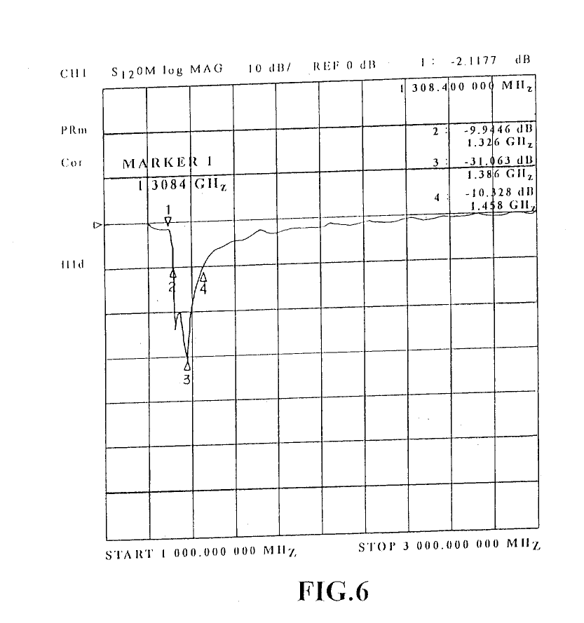

Properties of the band-trap filter 1 of the present invention made in the above-described manner are shown in FIGS. 5 and 6.

Please refer to FIGS. 5 and 6 that show two graphs in which waveforms obtained from tests conducted on the band-trap filter 1 are illustrated. It can be easily found from the waveforms obtained from the circuit tests, the band-trap filter of the present invention indeed has the functions of both low-pass and high-pass filters and is indeed a filter providing the band-trap effect.

The band-trap filter of the present invention has the following advantages as compared with other filters of prior art:

1. The band-trap filter 1 reduces the problem of electromagnetic interference and has functions of both low-pass and high-pass filters to provide excellent rejection effect that is not achievable with a conventional filter consisting of inductances and capacitances. Moreover, the band-trap filter 1 has an insertion loss between high and low pass bands that is so small that it would not have any significant influence on an energy loss of the pass bands.

2. The band-trap filter 1 has small volume adapted for use in various high-frequency circuit designs.

3. The band-trap filter 1 may be assembled in the manner of SMD.

4. The band-trap filter 1 can be made in simple manufacturing process at low cost while enabling effective rejection of electromagnetic interference.

The present invention has been described with a preferred embodiment thereof and it is understood that many changes and modifications in the described embodiment can be carried out without departing from the scope and the spirit of the invention as defined by the appended claims.

What is claimed is:

1. A band-trap filter, comprising a main body, an outer electrode, inner electrodes, first strip-shaped wires, a signal input, and a signal output;
said main body being made of a dielectric material and coated at all areas on four sides, including bottom, left, right, and rear sides, with said outer electrode; a top side of said main body also being coated with said outer electrode but being partially subjected to metallization to produce said signal input and said signal output;
said outer electrode coating top, bottom, left, right, and rear sides of said main body; portions of said outer electrode at the top and the bottom sides of said main body being electrically connected to each other by means of a second strip-shaped wire;
said inner electrodes being provided inside said main body to electrically connect thereto;
said signal input and said signal output being provided at the top side of said main body for connecting to a printed circuit board in order to input or output a signal; and
said first striped wires being provided on said main body to separately connect said signal input and said signal output to said inner electrodes;
whereby when said main body is formed, said electrodes are produced, and calibration and test for finished product are completed, said band-trap filter is formed to provide an electromagnetic interference rejection ability and functions of both low-pass and high-pass filters and thereby achieves a band-trap effect.

2. The band-trap filter as claimed in claim 1, wherein said main body may be formed into a single unit or a multi-layer plate by using a lathe, a miller or a compressing die or through a ceramic sintering process.

3. The band-trap filter as claimed in claim 1, wherein said dielectric material used to make said main body is one having a dielectric constant within the range from 2 to 200 or higher.

4. The band-trap filter as claimed in claim 1, wherein said metallization of the top side of said main body is achieved by vaporizing, chemically plating, electrically plating, or low-temperature sintering a material selected from the group consisting of copper, silver, gold, nickel, and tin.

5. The band-trap filter as claimed in claim 1, wherein said first strip-shaped wires are formed by vaporizing, chemically plating, electrically plating or low-temperature sintering a material selected from the group consisting of copper, silver, gold, nickel, and tin, or are in the form of metal film or metal wire.

6. The band-trap filter as claimed in claim 1, wherein said signal input and said signal output may be made into a shape of letter U, and are formed by removing said outer electrode at selected areas of the top side of said main body by sand blasting or cutting with suitable means, or using processes such as transfer printing, screen printing, and the like.
